(19) United States
(12) Patent Application Publication
(10) Pub. No.: US 2026/0109332 A1
(43) Pub. Date: Apr. 23, 2026

(54) BRAKE SYSTEM AND CONTROL METHOD THEREOF

(71) Applicant: HL Mando Corporation, Pyeongtaek (KR)

(72) Inventor: Seongnam KIM, Pyeongtaek (KR)

(21) Appl. No.: 19/080,846

(22) Filed: Mar. 15, 2025

(30) Foreign Application Priority Data
Oct. 18, 2024 (KR) 10-2024-0143333

(51) Int. Cl. B60T 8/92; B60T 8/172; B60T 8/1755

(52) U.S. Cl. CPC B60T 8/92; B60T 8/172; B60T 8/17551; B60T 2270/82

(57) ABSTRACT

A brake system includes an electromechanical brake provided on each of a plurality of wheels of a vehicle, and a control unit configured to set a target braking torque of the vehicle based on a signal received from a sensor unit provided on the vehicle, determine whether the electromechanical brake is abnormal, distribute the target braking torque based on the number of the electromechanical brakes in a fault state, set a target wheel torque of the electromechanical brake in a normal state, and control to generate a wheel braking torque smaller than the target wheel torque in the electromechanical brake in a normal state positioned on the same axis as the electromechanical brake in the fault state.

### CROSS-REFERENCE TO RELATED APPLICATIONS

This application claims the priority of Korean Patent Application No. 10-2024-0143333 filed on Oct. 18, 2024, in the Korean Intellectual Property Office, the disclosure of which is incorporated herein by reference.

### BACKGROUND

### Field

The present disclosure relates to a brake system and a control method thereof, and more specifically, to a brake system capable of performing stable braking even when an abnormality occurs in at least one of electromechanical brakes provided on each of a plurality of wheels of a vehicle, and a control method thereof.

### Description of the Related Art

Vehicles are essentially equipped with brake systems for braking, and various types of brake systems are being proposed to obtain stable and effective braking force.

A typical brake system mainly uses a disc that rotates with the wheel of the vehicle, a caliper on which a pair of pad plates are installed that can move back and forth to pressurize the disc, and a piston that is slidably installed on the caliper. When a driver steps on a brake pedal, brake fluid pressurizes the piston toward the disc side, thereby implementing braking of a wheel cylinder.

However, today, as a market demand for implementing various braking functions in detailed response to an operating environment of the vehicle increases, a method is being developed that receives a braking intention of the driver as an electrical signal when the driver steps on the brake pedal and generates braking force electromechanically using a motor and various gear structures.

In the brake system, an electromechanical brake is mounted on each of the four wheels of the vehicle and operated individually. Accordingly, in a case where at least one of the four electromechanical brakes is abnormal, when the brake system does not consider this and the remaining wheels operate normally, the vehicle may suddenly pull to one side, normal braking may be not performed, or an accident may even occur.

### SUMMARY

An aspect of the present disclosure is to provide a brake system and a control method thereof capable of stably and effectively performing braking when an abnormality occurs in at least one of electromechanical brakes provided in each of a plurality of wheels of a vehicle.

A brake system according to one aspect of the present disclosure includes: an electromechanical brake provided on each of a plurality of wheels of a vehicle; and a control unit configured to set a target braking torque of the vehicle based on a signal received from a sensor unit provided on the vehicle, determine whether the electromechanical brake is abnormal, distribute the target braking torque based on the number of the electromechanical brakes in a fault state, set a target wheel torque of the electromechanical brake in a normal state, and control to generate a wheel braking torque smaller than the target wheel torque in the electromechanical brake in a normal state positioned on the same axis as the electromechanical brake in the fault state.

The control unit may control braking of the electromechanical brake in the normal state by applying a torque control pattern with reference to the target wheel torque based on a position of the electromechanical brake in the fault state.

The control unit may control by applying the torque control pattern to the electromechanical brake in the normal state positioned on the same axis as the electromechanical brake in the fault state.

The control unit may control by applying the torque control pattern to the electromechanical brake in the normal state when two electromechanical brakes in the fault state are on the same side.

The torque control pattern may be set by applying a predetermined rising slope based on the target wheel torque for each control section.

The control section may include a first control section for controlling the wheel braking torque based on the target wheel torque up to a minimum wheel torque, a second control section for controlling the wheel braking torque based on a wheel torque control slope after reaching the minimum wheel torque, and a third control section for controlling the wheel braking torque based on the target wheel torque after the second control section.

The wheel torque control slope may vary to a predetermined value based on a slope factor.

The slope factor may be set as a product of a vehicle speed weight and an absolute value of a yaw rate.

The vehicle speed weight may vary to a predetermined value based on the speed of the vehicle.

The control unit may control the braking of the electromechanical brake in the normal state based on the target wheel torque when two electromechanical brakes in the normal state are in the same axial or diagonal position.

A control method of a brake system according to one aspect of the present disclosure includes: setting a target braking torque of a vehicle based on a signal received from a sensor unit provided in the vehicle; determining whether an electromechanical brake provided in each of four wheels of the vehicle is abnormal; distributing the target braking torque based on the number of the electromechanical brakes in a fault state and setting a target wheel torque of the electromechanical brake in a normal state; and controlling to generate a wheel braking torque smaller than the target wheel torque in the electromechanical brake in a normal state positioned on the same axis as the electromechanical brake in the fault state.

In the controlling of the braking of the electromechanical brake in the above normal state, the braking of the electromechanical brake in the normal state may be controlled by applying a torque control pattern based on the target wheel torque based on the position the electromechanical brake in the fault state.

In the controlling of the braking of the electromechanical brake in the normal state, the braking of the electromechanical brake in the above normal state may be controlled by applying the torque control pattern to the electromechanical brake in the normal state positioned on the same axis as the electromechanical brake in the fault state.

In the controlling of the braking of the electromechanical brake in the normal state, the braking of the electromechanical brake in the above normal state may be controlled by applying the torque control pattern to the electromechanical brake in the normal state when two electromechanical brakes in the fault state are on the same side.

The torque control pattern may be set by applying a predetermined rising slope based on the target wheel torque for each control section.

The control section may include a first control section for controlling the wheel braking torque based on the target wheel torque up to a minimum wheel torque, a second control section for controlling the wheel braking torque based on a wheel torque control slope after reaching the minimum wheel torque, and a third control section for controlling the wheel braking torque based on the target wheel torque after the second control section.

The wheel torque control slope may vary to a predetermined value based on a slope factor.

The slope factor may be set as a product of a vehicle speed weight and an absolute value of a yaw rate.

The vehicle speed weight may vary to a predetermined value based on the speed of the vehicle.

In the controlling of the braking of the electromechanical brake in the normal state, the braking of the electromechanical brake in the normal state may be controlled based on the target wheel torque when two electromechanical brakes in the normal state are in the same axial or diagonal position.

According to one aspect of the present disclosure, the braking stability of the brake device can be secured.

According to one aspect of the present disclosure, vehicle stability and braking response performance can be improved by right and left braking deviation.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a configuration of a brake system according to one exemplary embodiment of the present disclosure;

FIG. 2 is a diagram illustrating an example of an electromechanical brake according to one exemplary embodiment of the present disclosure;

FIG. 3 is a diagram illustrating an example of controlling an electromechanical brake in a normal state when three electromechanical brakes are in a fault state;

FIGS. 4 and 5 are diagrams illustrating examples of controlling an electromechanical brake in the normal state when two electromechanical brakes are in the fault state;

FIG. 6 is a diagram illustrating an example of controlling an electromechanical brake in the normal state when one electromechanical brake is in the fault state;

FIG. 7 is a diagram illustrating a torque control pattern for controlling an electromechanical brake in the brake system according to one exemplary embodiment of the present disclosure;

FIG. 8 is a diagram illustrating a relationship between a wheel torque control slope and a slope factor;

FIG. 9 is a diagram illustrating a relationship between a vehicle speed weight and a vehicle speed;

FIG. 10 is a diagram illustrating a control method of the brake system according to one exemplary embodiment of the present disclosure; and

FIG. 11 is a diagram illustrating the detailed process of FIG. 10.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The same reference numerals refer to the same elements throughout the specification. The present specification does not describe all elements of the exemplary embodiments, and any content that is general in the technical field to which the present disclosure belongs or that overlaps between the exemplary embodiments is omitted. The terms “unit, module, member, block” used in the specification can be implemented in software or hardware, and according to the exemplary embodiments, a plurality of “units, modules, members, blocks” can be implemented as a single element, or a single “unit, module, member, block”can include a plurality of elements.

Throughout the specification, when a part is said to be “connected” to another part, this includes not only a direct connection but also an indirect connection, and an indirect connection includes a connection via a wireless communications network.

Additionally, when a part is said to “include” a component, this does not mean that it excludes other components, but rather that it may include other components, unless otherwise specifically stated.

Throughout the specification, when it is said that an element is “on” another element, this includes not only cases where the element is in contact with the other element, but also cases where there is another element between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

The operation principle and exemplary embodiments of the present disclosure will be described with reference to the attached drawings below.

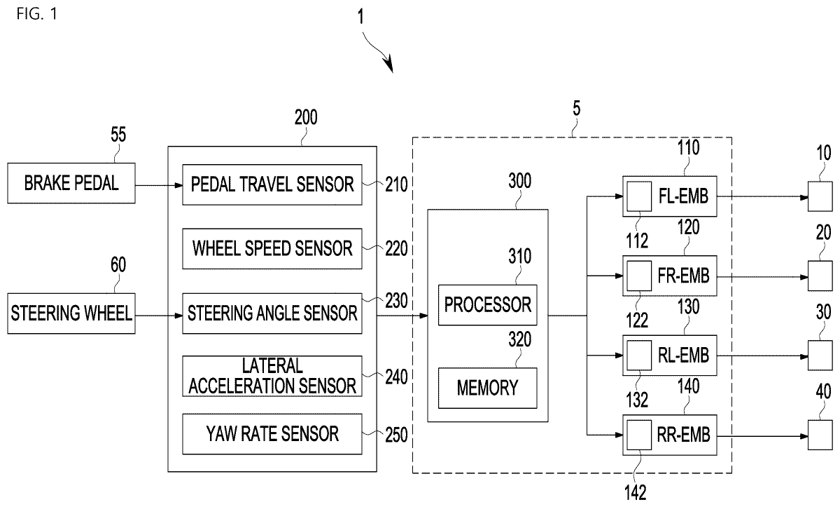

FIG. 1 is a diagram illustrating a configuration of a brake system according to one exemplary embodiment of the present disclosure.

Referring to FIG. 1, a vehicle 1 may include four rotating wheels 10, 20, 30 and 40.

The four wheels 10, 20, 30 and 40 may each include, for example, a first wheel 10 provided on a front left (FL) of the vehicle 1, a second wheel 20 provided on a front right (FR) of the vehicle 1, a third wheel 30 provided on a rear left (RL) of the vehicle 1, and/or a fourth wheel 40 provided on a rear right (RR) of the vehicle 1. However, the number of wheels 10, 20, 30 and 40 is not limited to four.

As illustrated in FIG. 1, a vehicle 1 may include a brake pedal 55 for obtaining input related to driver's braking, a pedal travel sensor 210 for detecting movement of the brake pedal 55, a wheel speed sensor 220 for detecting rotation speeds of wheels 10, 20, 30 and 40, a steering wheel 60 for obtaining input related to driver's steering, a steering angle sensor 230 for detecting rotation of the steering wheel 60, a lateral acceleration sensor 240 and a yaw rate sensor 250 for detecting behavior of the vehicle 1, and a brake system 5 for providing braking force to the wheels 10, 20, 30 and 40 to stop the vehicle.

Here, the pedal travel sensor 210, the wheel speed sensor 220, the lateral acceleration sensor 240, the yaw rate sensor 250, and the steering angle sensor 230 may be bundled into the sensor unit 200. In addition, the pedal travel sensor 210, the wheel speed sensor 220, the lateral acceleration sensor 240, the yaw rate sensor 250, and the steering angle sensor 230 are not essential components, and all or at least some of them may be omitted. In this way, the sensor unit 200 may output a signal corresponding to the behavior of the vehicle 1.

The brake system 5 may include electromechanical brakes (EMB) 110, 120, 130 and 140 installed on the wheels 10, 20, 30 and 40 and a control unit 300 that controls each of the electromechanical brakes 110, 120, 130 and 140.

The electromechanical brakes 110, 120, 130 and 140 may brake the wheels 10, 20, 30 and 40 and brake the vehicle 1. For example, the electromechanical brakes 110, 120, 130 and 140 may include a first brake 110 for braking the first wheel 10, a second brake 120 for braking the second wheel 12, a third brake 130 for braking the third wheel 13, and/or a fourth brake 140 for braking the fourth wheel 14. The number of electromechanical brakes 110, 120, 130 and 140 is not limited to four.

Each of the first brake 110, the second brake 120, the third brake 130, and the fourth brake 140 may be arranged to perform braking of each of the wheels 10, 20, 30 and 40 based on the control of the control unit 300. In addition, the first brake 110, the second brake 120, the third brake 130, and the fourth brake 140 may include a first control unit 112, a second control unit 122, a third control unit 132, and a fourth control unit 142 that perform braking control, respectively.

Each of the first control unit 112, the second control unit 122, the third control unit 132, and the fourth control unit 142 is an electronic control unit (ECU) and may perform braking control of the first brake 110, the second brake 120, the third brake 130, and the fourth brake 140 in the wheels 10, 20, 30 and 40 based on the control of the control unit 300. For example, each of the first control unit 112, the second control unit 122, the third control unit 132, and the fourth control unit 142 may control an actuator according to the braking torque received from the control unit 300.

The wheel braking torque generated from each of the wheels 10, 20, 30 and 40 is measured by the sensor unit 200, and the measured wheel braking torque may be fed back to the control unit 300, the first control unit 112, the second control unit 122, the third control unit 132, and the fourth control unit 142.

Each of the first control unit 112, the second control unit 122, the third control unit 132, and the fourth control unit 142 may perform torque feedback control to adjust actuator control using the fed-back wheel braking torque. In addition, the first control unit 112, the second control unit 122, the third control unit 132, and the fourth control unit 142 may control the first brake 110, the second brake 120, the third brake 130, and the fourth brake 140 so that the fed-back wheel braking torque corresponds to a target braking torque of the vehicle 1 and/or a target wheel torque of each of the wheels 10, 20, 30 and 40 to be described later. Additionally, each of the first control unit 112, the second control unit 122, the third control unit 132, and the fourth control unit 142 may dynamically adjust the braking torque by updating the control for the actuator according to changes in traveling conditions such as the speed of the vehicle, the behavior of the vehicle, or road conditions.

However, the roles of each of the first control unit 112, the second control unit 122, the third control unit 132, and the fourth control unit 142 are not limited thereto, and any one of the first control unit 112, the second control unit 122, the third control unit 132, and the fourth control unit 142 may perform the role of the control unit 300 as needed.

Each of the electromechanical brakes 110, 120, 130 and 140 may operate solely based on the braking signal output from the control unit 300 without being mechanically or fluidically connected to the brake pedal 55.

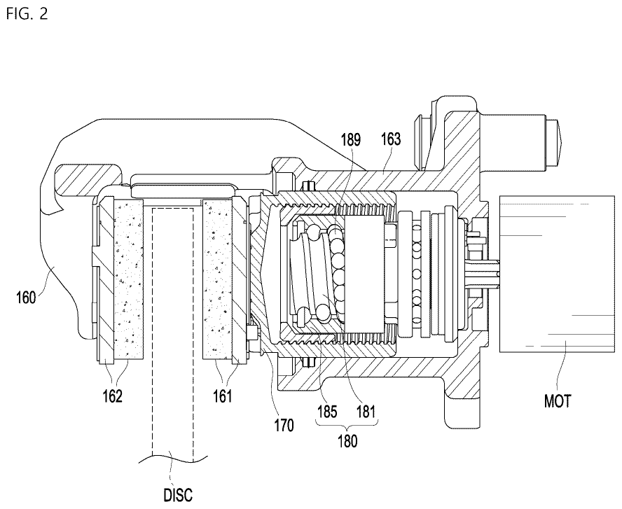

For example, as illustrated in FIG. 2, each of the electromechanical brakes 110, 120, 130 and 140 may include a caliper brake.

The caliper brake may include a pair of pad plates 161 and 162 installed to pressurize a brake disc DISC that rotates together with each of the wheels 10, 20, 30 and 40, a caliper housing 160 that operates the pair of pad plates 161 and 162, a piston 170 that is installed to be movable back and forth inside the caliper housing 160, a power conversion unit 180 that receives a rotational driving force for moving the piston 170, converts the rotational driving force into a linear driving force, and transmits the linear driving force to the piston 170, and a brake motor MOT that generates a rotational driving force for moving the piston 170. The pair of pad plates 161 and 162, the caliper housing 160, the piston 170, the power conversion unit 180, and the brake motor MOT are not essential components, and all or at least some of them may be omitted.

The piston 170 may be provided in a cup shape with the rear side (right side of FIG. 2) open, and may be inserted so as to be slidable inside a cylinder portion 163. In addition, the piston 170 may receive power through the power conversion unit 180 to pressurize the inner pad plate 161 toward the brake disc DISC.

The power conversion unit 180 may include a spindle 181 that receives driving force from a brake motor MOT and rotates, a nut 185 that is disposed inside the piston 170 and is screw-connected to the spindle 181 so as to advance together with the piston 170 by a first direction rotation of the spindle 181 or retreat together with the piston 170 by a second direction rotation of the spindle 181, and a plurality of balls 189 interposed between the spindle 181 and the nut 185. This power conversion unit 180 may be provided as a ball-screw type conversion device that converts the rotational motion of the spindle 181 into linear motion.

The rotational motion of the brake motor MOT may be converted into the linear motion of the piston 170 by the power conversion unit 180. By the linear motion of the piston 170, a pair of pad plates 161 and 162 are pressed toward the brake disc DISC, and the wheels 10, 20, 30 and 40 may be braked by the friction between the pair of pad plates 161 and 162 and the brake disc DISC.

FIG. 2 illustrates a caliper brake as an example of an electromechanical brake, but the electromechanical brake is not limited to the caliper brake. For example, the electromechanical brake may be a drum brake.

The control unit 300 may include a processor 310 and a memory 320.

The processor 310 may control the overall operation of the brake system 5.

The memory 320 may store programs for processing or controlling the processor 310 and various data for operating the brake system 5. For example, the memory 320 may include not only volatile memory such as S-RAM and D-RAM, but also nonvolatile memory such as flash memory, read only memory (ROM), and erasable programmable read only memory (EPROM).

The control unit 300 may control the braking of the vehicle 1 based on a signal received from the sensor unit 200 provided in the vehicle.

The control unit 300 may set a target braking torque of the vehicle 1 corresponding to driver's requested braking torque based on the signal received from the sensor unit 200. For example, the control unit 300 may set the target braking torque of the vehicle 1 by reflecting the driver's requested braking torque calculated from the pedal travel sensor 210. In addition, the control unit 300 may set the target wheel torque to be distributed to the electromechanical brakes 110, 120, 130 and 140 of the wheels 10, 20, 30 and 40 based on the target braking torque.

Here, the target braking torque may refer to the braking torque to be distributed to the four wheels 10, 20, 30 and 40 for braking the vehicle based on the vehicle speed, steering angle, lateral acceleration, yaw rate, driver-requested braking torque, and ADAS-requested braking torque according to an advanced driver assistance system (ADAS) function. In addition, the target braking torque may be set based on a larger value between the driver-requested braking torque and the ADAS-requested braking torque according to the advanced driver assistance system (ADAS) function. For example, the target braking torque may be set to about 1600 Nm.

The target wheel torque may mean the braking torque distributed to each of the four wheels 10, 20, 30 and 40 based on the target braking torque. For example, the target wheel torque may be set to about 400 Nm.

The control unit 300 may calculate the speed of the vehicle based on the signal received from the sensor unit 200. For example, the control unit 300 may calculate the speed of the vehicle by receiving a wheel speed detection signal detected by the wheel speed sensor 220.

Additionally, the control unit 300 may calculate a target vehicle deceleration based on the calculated vehicle speed and driver's requested braking torque.

The control unit 300 may detect and/or determine whether there is an abnormality (normal state, fault state) in the electromechanical brakes 110, 120, 130 and 140 provided on the wheels 10, 20, 30 and 40 by communicating with the electromechanical brakes 110, 120, 130 and 140. For example, when the control unit 300 receives an abnormal signal from the electromechanical brakes 110, 120, 130 and 140 or when communication is cut off, the control unit 300 may detect and/or determine that there is an abnormality (fault state) in the corresponding electromechanical brakes 110, 120, 130 and 140. Here, the control unit 300 may communicate with the electromechanical brakes 110, 120, 130 and 140 and the sensor unit 200 using a vehicle communication network such as Ethernet, media oriented systems transport (MOST), Flexray, a controller area network (CAN), and a local interconnect network (LIN).

When all electromechanical brakes 110, 120, 130 and 140 are in a normal state, the control unit 300 may distribute target braking torque in the normal mode to set the target wheel torque, and control the electromechanical brakes 110, 120, 130 and 140 of the wheels 10, 20, 30 and 40 based on the set target wheel torque.

When at least one of the electromechanical brakes 110, 120, 130 and 140 is in a fault state, the control unit 300 may distribute the target braking torque to the electromechanical brakes 110, 120, 130 and 140 in the normal state except for the electromechanical brakes 110, 120, 130 and 140 in the fault state in a fault mode to set the target wheel torque, and control the electromechanical brakes 110, 120, 130 and 140 in the normal state based on the set target wheel torque.

For example, in a failure mode, the target wheel torques of the electromechanical brakes 110, 120, 130 and 140 in the normal state may be set to a value obtained by multiplying the target braking torque by a gain value and then dividing the result by the number of the failed electromechanical brakes 110, 120, 130 and 140. Here, the gain value may be varied according to the braking force distribution of the front and rear wheels. When the braking force distribution of the front and rear wheels is the same, the gain value may be set to 1, and in other cases, the gain value may be varied.

In this case, the control unit 300 may set the target wheel torques of the electromechanical brakes 110, 120, 130, and 140 in the normal state based on the number of the electromechanical brakes 110, 120, 130, and 140 in the fault state. In addition, the control unit 300 may control the braking of the electromechanical brakes 110, 120, 130 and 140 in the normal state based on the target wheel torque based on the positions of the electromechanical brakes 110, 120, 130 and 140 in the fault state. However, here, the control of the electromechanical brakes 110, 120, 130 and 140 is described only when the vehicle is moving straight, without considering the turning of the vehicle.

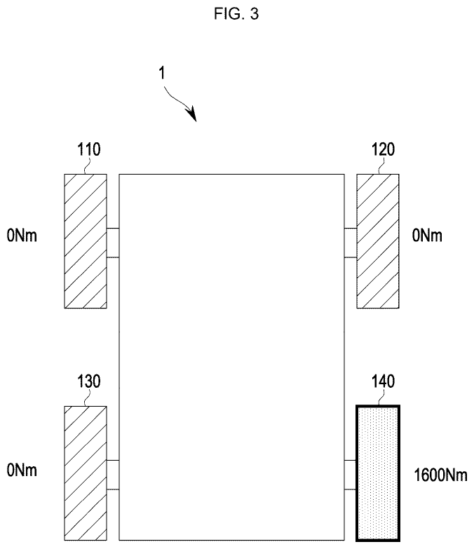

FIG. 3 is a diagram illustrating an example of controlling the electromechanical brake in the normal state when three electromechanical brakes are in the fault state.

Referring to FIG. 3, when three electromechanical brakes 110, 120 and 130 are faulty, the control unit 300 distributes the target braking torque to set the target wheel torque of one electromechanical brake 140 in the normal state, and applies a torque control pattern to be described later based on the set target wheel torque to control the braking of the electromechanical brake 140 in the normal state.

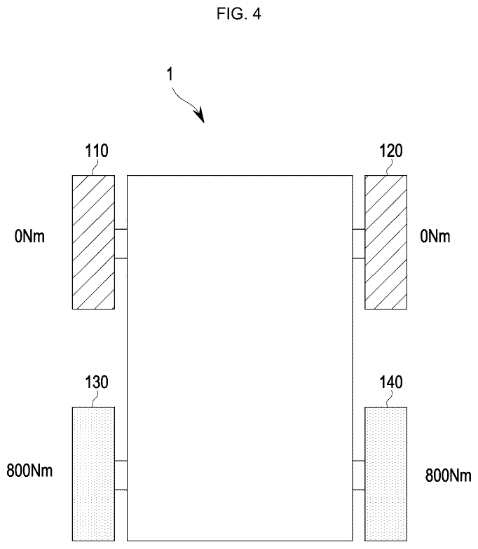

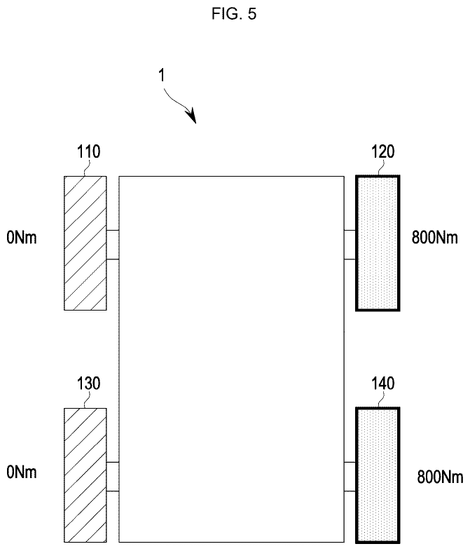

FIGS. 4 and 5 are diagrams illustrating examples of controlling the electromechanical brake in the normal state when two electromechanical brakes are in the fault state.

Referring to FIG. 4, when two electromechanical brakes 110 and 120 are faulty, the control unit 300 may distribute the target braking torque to set target wheel torques of two electromechanical brakes 130 and 140 in the normal state. In addition, the control unit 300 may check the positions of two electromechanical brakes 110 and 120 in the fault state, and control braking of two electromechanical brakes 130 and 140 in the normal state based on target wheel torque set based on the positions of electromechanical brakes 110 and 120 in the fault state.

For example, when two electromechanical brakes 110 and 120 in the fault state are in the same axis (front wheel or rear wheel) or diagonal positions (front left wheel and rear right wheel, or front right wheel and rear left wheel) based on four wheels 10, 20, 30 and 40, the control unit 300 may distribute the target braking torque to set the target wheel torques of the two electromechanical brakes 130 and 140 in the normal state, and control the braking of the two electromechanical brakes 130 and 140 in the normal state with the set target wheel torque.

Referring to FIG. 5, when two electromechanical brakes 110 and 130 in the fault state are on the same side (left side of the vehicle) based on four wheels 10, 20, 30 and 40, the control unit 300 may distribute the target braking torque to set target wheel torques of two electromechanical brakes 120 and 140 in the normal state, and apply the torque control pattern to be described later based on the set target wheel torques to control braking of two electromechanical brakes 120 and 140 in the normal state.

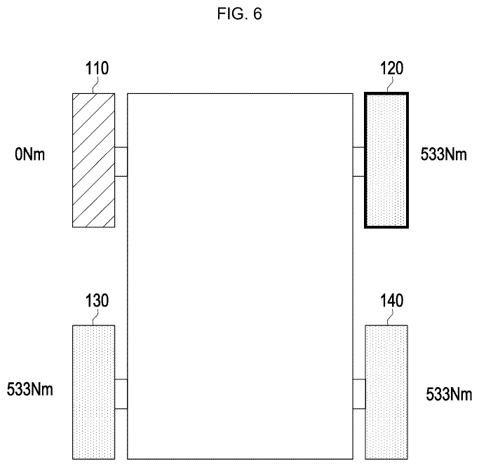

FIG. 6 is a diagram illustrating an example of controlling the electromechanical brake in the normal state when one electromechanical brake is in the fault state.

Referring to FIG. 6, when one electromechanical brake 110 is faulty, the control unit 300 may distribute the target braking torque to set the target wheel torques of three electromechanical brakes 120, 130 and 140 in the normal state. In addition, the control unit 300 may control by applying the torque control pattern based on the target wheel torque set for the electromechanical brake 120 positioned on the same axis as the electromechanical brake 110 in the fault state among the three electromechanical brakes 120, 130 and 140 in the normal state. In addition, the control unit 300 may control by applying the target wheel torques to the remaining two electromechanical brakes 130 and 140 in the normal state.

Alternatively, in a case where one or three of the electromechanical brakes 110, 120, 130, and 140 are in the fault state, the control unit 300 may control by applying the torque control pattern based on the target wheel torque to the electromechanical brakes 110, 120, 130 and 140 in the normal state positioned on the same axis as the electromechanical brakes 110, 120, 130 and 140 in the fault state.

In addition, in a case where one or two of the electromechanical brakes 110, 120, 130, and 140 are in the fault state, two of the electromechanical brakes 110, 120, 130 and 140 in the normal state are in the same axial or diagonal positions, the control unit 300 may control the braking of the electromechanical brakes 110, 120, 130 and 140 in the normal state based on the target wheel torque.

In addition, in a case where two of the electromechanical brakes 110, 120, 130, and 140 are in the fault state, two of the electromechanical brakes 110, 120, 130 and 140 in the normal state are in the same axial, the control unit 300 may control the braking of the electromechanical brakes 110, 120, 130 and 140 in the normal state by applying the torque control pattern based on the target wheel torque.

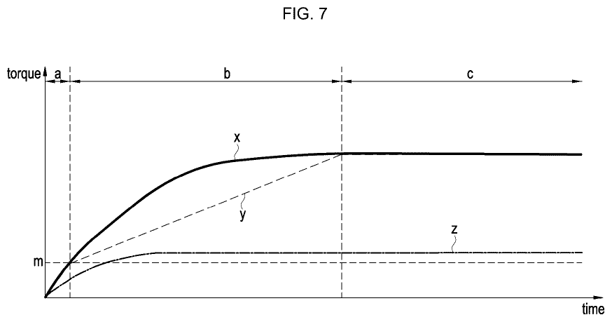

FIG. 7 is a diagram illustrating a torque control pattern for controlling the electromechanical brake in the brake system according to one exemplary embodiment of the present disclosure.

Referring to FIG. 7, the torque control pattern may be set by applying a predetermined rising slope based on a target wheel torque x for each control section.

Here, the control section may include a first control section a for controlling a wheel braking torque y based on the target wheel torque x up to a minimum wheel torque m, a second control section b for controlling the wheel braking torque y based on the wheel torque control slope after reaching the minimum wheel torque m, and a third control section c for controlling the wheel braking torque y based on the target wheel torque x after the second control section b. In addition, the minimum wheel torque means a minimum wheel torque applied to the electromechanical brakes 110, 120, 130 and 140 to perform the braking of the vehicle, and may be set through a test.

Here, the torque control pattern may be set to generate the wheel control torque y smaller than the target wheel torque x to prevent sudden movement of the vehicle 1 when the electromechanical brakes 110, 120, 130 and 140 fail.

Accordingly, the control unit 300 may control to generate the wheel control torque y smaller than the target wheel torque X by applying the torque control pattern to the electromechanical brakes 110, 120, 130 and 140 in the normal state positioned on the same axis as the electromechanical brakes 110, 120, 130 and 140 in the fault state.

As illustrated in FIG. 7, the control unit 300 may control the wheel braking torque y of the electromechanical brakes 110, 120, 130 and 140 to be equal to or similar to the target wheel torque x up to the minimum wheel torque m in the first control section a.

In addition, the control unit 300 may control the wheel braking torque y of the electromechanical brakes 110, 120, 130 and 140 based on the wheel torque control slope after reaching the minimum wheel torque m. Here, the wheel torque control slope may be varied according to stability (for example, lateral acceleration, yaw rate, or the like) of the vehicle behavior based on the signal received from the sensor unit 200. In addition, the wheel torque control slope may be set to generate the wheel control torque y smaller than the target wheel torque x.

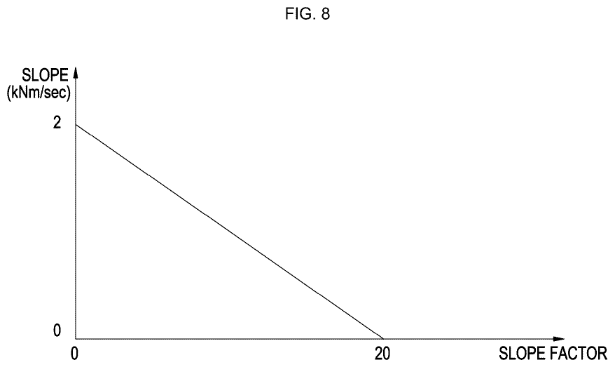

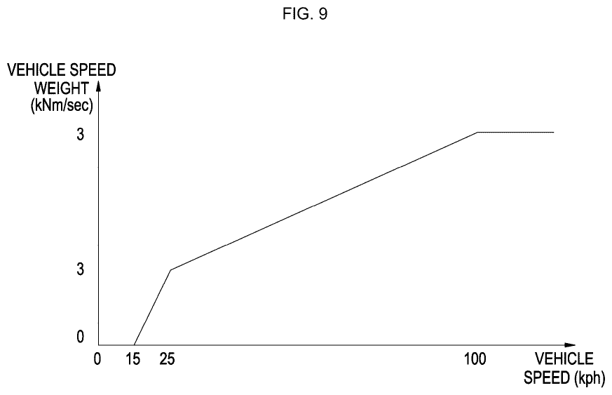

Here, the wheel torque control slope may be set to have a constant rising slope during the second control section b. In addition, the wheel torque control slope may be set to generate the wheel control torque y that is reduced by a predetermined amount from the target wheel torque x so that a sudden movement of the vehicle 1 does not occur. This method of setting the wheel torque control slope is described below with reference to FIGS. 8 and 9.

For reference, when there is no abnormality in all electromechanical brakes 110, 120, 130 and 140, the control unit 300 may control the braking of the electromechanical brakes 110, 120, 130 and 140 with a target wheel torque z set in normal mode.

FIG. 8 is a diagram illustrating a relationship between the wheel torque control slope and the slope factor.

Referring to FIG. 8, the wheel torque control slope may be set by interpolation and may be varied to a predetermined value based on the slope factor. In this case, the wheel torque control slope may be set to a range of 0 to a maximum value or an upper limit. In addition, the slope factor may be set as a product of the vehicle speed weight and an absolute value of the yaw rate.

FIG. 9 is a diagram illustrating the relationship between the vehicle speed weight and the vehicle speed.

Referring to FIG. 9, the vehicle speed weight may be set by interpolation and may be varied to a predetermined value based on the vehicle speed. For example, the vehicle speed weight may be set to 0 when the vehicle speed is about 15 kph, 1 when the vehicle speed is about 25 kph, and 3 when the vehicle speed is about 100 kph. However, the vehicle speed weight described above is only an example, and the values or factors may be additionally changed.

The control unit 300 controls the braking of the electromechanical brakes 110, 120, 130 and 140 in the normal state positioned on the same axis as the electromechanical brakes 110, 120, 130 and 140 in the fault state based on the torque control pattern, thereby preventing the vehicle from suddenly rolling due to the braking of the electromechanical brakes 110, 120, 130 and 140 in the normal state, and ensuring time for the driver or the steering system to control the body of the vehicle.

Accordingly, the brake system according to one exemplary embodiment of the present disclosure may improve the stability of the vehicle by enabling stable braking control even when an abnormality occurs in at least one of the electromechanical brakes 110, 120, 130 and 140 provided on the wheels 10, 20, 30 and 40 of the vehicle.

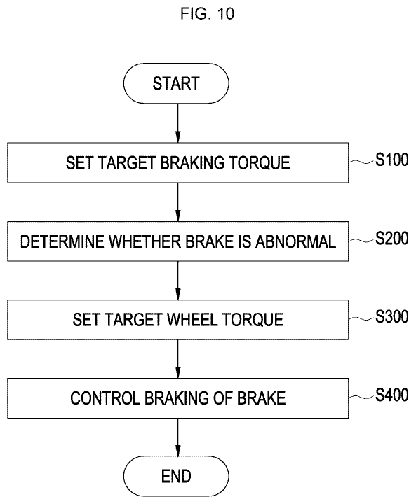

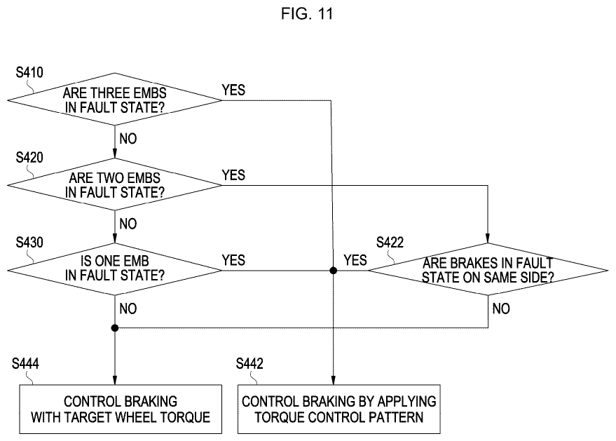

Hereinafter, a control method of the brake system according to one exemplary embodiment of the present disclosure with reference to FIGS. 10 and 11 will be described. Here, the control method is described based on the brake system according to the above-described exemplary embodiment.

FIG. 10 is a diagram illustrating a control method of a brake system according to one exemplary embodiment of the present disclosure. FIG. 11 is a diagram illustrating a detailed process of FIG. 10.

Referring to FIGS. 10 and 11, the control method of a brake system according to one exemplary embodiment may include setting a target braking torque of a vehicle based on a signal received from a sensor unit provided in the vehicle (S100), determining whether an electromechanical brake provided in each of four wheels of the vehicle is abnormal (S200), distributing the target braking torque based on the number of the electromechanical brakes in a fault state and setting a target wheel torque of the electromechanical brake in a normal state (S300), and controlling the braking of the electromechanical brake in a normal state based on the target wheel torque (S400).

Specifically, the control unit may set target braking torque to be distributed to four wheels for braking of the vehicle based on the vehicle speed, steering angle, lateral acceleration, yaw rate, driver's braking request torque, and ADAS-request braking torque (S100).

Next, the control unit may detect and/or determine whether there is an abnormality (normal state, fault state) in the electromechanical brake by communicating with the electromechanical brake provided on each wheel of the vehicle (S200). For example, when the control unit receives an abnormal signal from the electromechanical brake or communication is cut off, the control unit may detect and/or determine whether there is an abnormality (fault state) in the corresponding electromechanical brake.

Next, the control unit may set the target wheel torque of the electromechanical brakes in the normal state based on the number of electromechanical brakes in the fault state (S300). When all electromechanical brakes are in the normal state, the control unit may set the target wheel torque of the electromechanical brakes in the normal state by distributing the target braking torque in the normal mode.

When three electromechanical brakes are in the fault state, the control unit may set the target wheel torque of one electromechanical brake in the normal state in response to the target braking torque. When two electromechanical brakes are in the fault state, the control unit may set the target wheel torque of two electromechanical brakes in the normal state in response to the target braking torque. When one electromechanical brake is in the fault state, the control unit may set the target wheel torque of three electromechanical brakes in the normal state in response to the target braking torque.

Next, the control unit may control the braking of the electromechanical brake in the normal state based on the target wheel torque (S400). Here, the control unit may control the braking of the electromechanical brake in the normal state by applying a torque control pattern based on the target wheel torque based on the position of the electromechanical brake in the fault state.

When three electromechanical brakes are in the fault state (S410), the braking of the electromechanical brakes in the normal state may be controlled by applying the torque control pattern based on the target wheel torque (S442).

When two electromechanical brakes are in the fault state (S420), it is checked whether the positions of the electromechanical brakes in the fault state are on the same side (S422), and when two electromechanical brakes are on the same side, the braking of the electromechanical brake in the normal state may be controlled by applying the torque control pattern based on the target wheel torque (S442). When they are not on the same side, the braking of the electromechanical brake in the normal state may be controlled by the target wheel torque (S444).

When one electromechanical brake is in the fault state (S420), the braking of the electromechanical brake in the normal state may be controlled by applying a torque control pattern based on the target wheel torque (S442).

Alternatively, when there are one or three electromechanical brakes in the fault state, the control unit may control by applying the torque control pattern based on the target wheel torque to the electromechanical brake in the normal state positioned on the same axis as the electromechanical brake in the fault state.

Additionally, in a case where there are one or two electromechanical brakes in the fault state, when the two electromechanical brakes in the normal state are in the same axial or diagonal position, the control unit may control the braking of the electromechanical brake in the normal state based on the target wheel torque.

Additionally, in a case where there are two electromechanical brakes in the fault state, when the two electromechanical brakes in the normal state are on the same side, the control unit may control the braking of the electromechanical brake in the normal state by applying the torque control pattern based on the target wheel torque.

Here, the torque control pattern may be set by applying a predetermined rising slope based on the target wheel torque for each control section. In this case, the control section may include a first control section for controlling the wheel braking torque based on the target wheel torque up to the minimum wheel torque, a second control section for controlling the wheel braking torque based on the wheel torque control slope after reaching the minimum wheel torque, and a third control section for controlling the wheel braking torque based on the target wheel torque after the second control section.

Here, the torque control pattern may be set to generate the wheel control torque smaller than the target wheel torque to prevent sudden vehicle movement when the electromechanical brake fails.

Accordingly, the control unit may control to generate the wheel control torque smaller than the target wheel torque by applying the torque control pattern to the electromechanical brake in the normal state positioned on the same axis as the electromechanical brake in the fault state.

More specifically, the control unit may control the wheel braking torque of the electromechanical brake to be equal to or similar to the target wheel torque up to the minimum wheel torque in the first control section. In addition, the control unit may control the wheel braking torque of the electromechanical brake based on the wheel torque control slope after reaching the minimum wheel torque. Here, the wheel torque control slope may be varied according to the behavior stability of the vehicle based on the signal received from the sensor unit. In addition, the wheel torque control slope may be set to generate the wheel control torque smaller than the target wheel torque.

Here, the wheel torque control slope may be set to have a constant rising slope during the second control section. In addition, the wheel torque control slope may be set to generate the wheel control torque that is reduced by a predetermined amount from the target wheel torque so as to prevent sudden vehicle movement.

The control unit controls the braking 44 the electromechanical brake in the normal state positioned on the same axis as the electromechanical brake in the fault state based on the torque control pattern, thereby preventing the vehicle from abruptly rolling due to the braking of the electromechanical brake in the normal state, and ensuring time for the driver or the steering system to control the body of the vehicle.

Accordingly, the control method of the brake system according to one exemplary embodiment of the present disclosure may improve the stability of the vehicle by enabling stable braking control even when an abnormality occurs in at least one of the electromechanical brake devices provided for each wheel of the vehicle.

Meanwhile, the disclosed exemplary embodiments may be implemented in the form of a recording medium storing instructions executable by a computer. The instructions may be stored in the form of program codes, and when executed by a processor, may generate program modules to perform the operations of the disclosed exemplary embodiments. The recording medium may be implemented as a computer-readable recording medium.

Computer-readable storage media include all types of storage media that store instructions that can be deciphered by a computer. Examples include a read only memory (ROM), a random-access memory (RAM), a magnetic tape, a magnetic disk, a flash memory, and an optical data storage device, or the like.

A storage medium that can be read by the device may be provided in the form of a non-transitory storage medium. Here, “non-transitory” means only that the storage medium is a tangible device and does not contain signals (for example, electromagnetic waves), and the term does not distinguish between cases where data is stored semi-permanently in the storage medium and cases where data is stored temporarily. For example, a “non-transitory storage medium” may include a buffer in which data is temporarily stored.

As described above, the disclosed exemplary embodiments have been described with reference to the attached drawings. Those skilled in the art to which the present disclosure pertains will understand that the present disclosure can be implemented in forms other than the disclosed exemplary embodiments without changing the technical idea or essential features of the present disclosure. The disclosed exemplary embodiments are exemplary and should not be construed as limiting.

What is claimed is:

1. A brake system comprising:
an electromechanical brake provided on each of a plurality of wheels of a vehicle; and
a control unit configured to set a target braking torque of the vehicle based on a signal received from a sensor unit provided on the vehicle, determine whether the electromechanical brake is abnormal, distribute the target braking torque based on the number of the electromechanical brakes in a fault state, set a target wheel torque of the electromechanical brake in a normal state, and control to generate a wheel braking torque smaller than the target wheel torque in the electromechanical brake in the normal state positioned on the same axis as the electromechanical brake in the fault state.

2. The brake system according to claim 1, wherein the control unit controls to generate the wheel braking torque by applying a torque control pattern set based on the signal received from the sensor unit according to a position of the electromechanical brake in the fault state.

3. The brake system according to claim 2, wherein the control unit controls by applying the torque control pattern to the electromechanical brake in the normal state positioned on the same axis as the electromechanical brake in the fault state.

4. The brake system according to claim 2, wherein the control unit controls by applying the torque control pattern to the electromechanical brake in the normal state when two electromechanical brakes in the fault state are on the same side.

5. The brake system according to claim 2, wherein the torque control pattern is set by applying a predetermined rising slope based on the target wheel torque for each control section.

6. The brake system according to claim 5, wherein the control section includes a first control section for controlling the wheel braking torque based on the target wheel torque up to a minimum wheel torque, a second control section for controlling the wheel braking torque based on a wheel torque control slope after reaching the minimum wheel torque, and a third control section for controlling the wheel braking torque based on the target wheel torque after the second control section.

7. The brake system according to claim 6, wherein the wheel torque control slope varies to a predetermined value based on a slope factor.

8. The brake system according to claim 7, wherein the slope factor is set as a product of a vehicle speed weight and an absolute value of a yaw rate.

9. The brake system according to claim 8, wherein the vehicle speed weight varies to a predetermined value based on a speed of the vehicle.

10. The brake system according to claim 1, wherein the control unit controls braking of the electromechanical brake in the normal state based on the target wheel torque when two electromechanical brakes in the normal state are in the same axial or diagonal position.

11. A control method of a brake system, the control method comprising:
setting a target braking torque of a vehicle based on a signal received from a sensor unit provided in the vehicle;
determining whether an electromechanical brake provided in each of four wheels of the vehicle is abnormal;
distributing the target braking torque based on the number of the electromechanical brakes in a fault state and setting a target wheel torque of the electromechanical brake in a normal state; and
controlling to generate a wheel braking torque smaller than the target wheel torque in the electromechanical brake in the normal state positioned on the same axis as the electromechanical brake in the fault state.

12. The control method according to claim 11, wherein in the controlling of the braking of the electromechanical brake in the normal state,
the braking of the electromechanical brake in the normal state is controlled by applying a torque control pattern set based on the signal received from the sensor unit according to a position of the electromechanical brake in the fault state.

13. The control method according to claim 12, wherein in the controlling of the braking of the electromechanical brake in the normal state,
the control is performed by applying the torque control pattern to the electromechanical brake in the normal state positioned on the same axis as the electromechanical brake in the fault state.

14. The control method according to claim 13, wherein in the controlling of the braking of the electromechanical brake in the normal state,
the control is performed by applying the torque control pattern to the electromechanical brake in the normal state when two electromechanical brakes in the fault state are on the same side.

15. The control method according to claim 12, the torque control pattern is set by applying a predetermined rising slope based on the target wheel torque for each control section.

16. The control method according to claim 15, wherein the control section includes a first control section for controlling the wheel braking torque based on the target wheel torque up to a minimum wheel torque, a second control section for controlling the wheel braking torque based on a wheel torque control slope after reaching the minimum wheel torque, and a third control section for controlling the wheel braking torque based on the target wheel torque after the second control section.

17. The control method according to claim 16, wherein the wheel torque control slope varies to a predetermined value based on a slope factor.

18. The control method according to claim 17, wherein the slope factor is set as a product of a vehicle speed weight and an absolute value of a yaw rate.

19. The control method according to claim 18, wherein the vehicle speed weight varies to a predetermined value based on a speed of the vehicle.

20. The control method according to claim 11, wherein in the controlling of the braking of the electromechanical brake in the normal state,
the braking of the electromechanical brake in the normal state is controlled based on the target wheel torque when two electromechanical brakes in the normal state are in the same axial or diagonal position.
